(19) United States
(12) Patent Application Publication
(10) Pub. No.: US 2025/0307720 A1
(43) Pub. Date: Oct. 2, 2025

(54) SEAT RESERVATION SYSTEM AND SEAT RESERVATION METHOD

(71) Applicant: TOYOTA JIDOSHA KABUSHIKI KAISHA, Toyota-shi Aichi-ken (JP)

(72) Inventors: Hiroya CHIBA, Fuji-shi Shizuoka-ken (JP); Rika OIKE, Shizuoka-shi Shizuoka-ken (JP)

(73) Assignee: TOYOTA JIDOSHA KABUSHIKI KAISHA, Toyota-shi Aichi-ken (JP)

(21) Appl. No.: 19/043,561

(22) Filed: Feb. 3, 2025

(30) Foreign Application Priority Data
Mar. 26, 2024 (JP) 2024-049602

(51) Int. Cl. G06Q 10/02

(52) U.S. Cl. CPC G06Q 10/02

(57) ABSTRACT

A processor of a seat reservation system searches for a same seat satisfying a desired seat condition throughout a use route, based on seat arrangement information, seat reservation information, use route information, and seat condition information stored in a memory device. When the same seat does not exist, the processor searches for a combination of a plurality of seats satisfying the desired seat condition. When a plurality of combinations exist as a plurality of combination candidates, the processor executes a score calculation process of calculating, for each of the plurality of combination candidates, a movement burden score indicating a magnitude of burden of movement of the user between the plurality of seats, based on the seat arrangement information and the seat reservation information. The processor presents to the user via a user device, a combination candidate having a smallest movement burden score among the plurality of combination candidates.

### CROSS-REFERENCES TO RELATED APPLICATION

The present disclosure claims priority under 35 U.S.C. § 119 to Japanese Patent Application No. 2024-049602, filed on Mar. 26, 2024, which is incorporated herein by reference in its entirety.

### BACKGROUND

### Technical Field

The present disclosure relates to a seat reservation system and a seat reservation method for managing seat reservations of a passenger vehicle.

### Background Art

JP 2004-265167 A discloses an information processing device for reserving a reserved seat of a vehicle. When there is at least one vacant seat in each unit section constituting a use route used by a user and there is no common vacant seat throughout the use route, the information processing device specifies a combination pattern of respective vacant seats in the unit sections covering the use route.

Moreover, JP 2006-221254 A discloses a seat management system. When a passenger moves to a more favorable seat, this seat management system releases a seat seated by the passenger before the movement, and sets a newly seated seat as the reserved seat for the passenger. Furthermore, JP 2011-048414 A discloses a seat reservation system. In this seat reservation system, when a seat according to seat request information is not a vacant seat, a riding section included in the seat request information is divided into a plurality of riding sections. The seat reservation system extracts vacant seats in the divided riding sections, and then extracts information on seats at a short distance from among the extracted vacant seats.

### SUMMARY

When a user who requests a seat reservation for a passenger vehicle for a use route including a plurality of sections cannot obtain the same seat throughout the use route, it is conceivable to present a combination of a plurality of seats involving movement of the user between seats as in the technique described in JP 2004-265167 A. It is desirable to perform this kind of presentation of the combination of the plurality of seats while more sufficiently improving the convenience of the user.

A seat reservation system according to the present disclosure manages seat reservations for a passenger vehicle. The seat reservation system includes one or more memory devices and one or more processors. The one or more memory devices are configured to store seat arrangement information of the passenger vehicle, seat reservation information indicating a seat reservation status for individual sections traveled by the passenger vehicle, use route information indicating a use route that is used by a user and includes a plurality of sections traveled by the passenger vehicle, and seat condition information indicating a desired seat condition of the user. The one or more processors are configured to: search for a same seat satisfying the desired seat condition throughout the use route, based on the seat arrangement information, the seat reservation information, the use route information, and the seat condition information; when the same seat does not exist, search for a combination of a plurality of seats satisfying the desired seat condition throughout the use route; when a plurality of combinations exist as a plurality of combination candidates of the combination, execute a score calculation process of calculating, for each of the plurality of combination candidates, a movement burden score indicating a magnitude of burden of movement of the user between the plurality of seats, based on the seat arrangement information and the seat reservation information; and present, to the user via a user device of the user, a combination candidate having a smallest movement burden score among the plurality of combination candidates.

A seat reservation method according to the present disclosure manages seat reservations for a passenger vehicle. The seat reservation method, which is executed by a computer, includes: searching for a same seat satisfying a desired seat condition of a user throughout a use route, based on seat arrangement information of the passenger vehicle, seat reservation information indicating a seat reservation status for individual sections traveled by the passenger vehicle, use route information indicating the use route that is used by the user and includes a plurality of sections traveled by the passenger vehicle, and seat condition information indicating the desired seat condition; when the same seat does not exist, searching for a combination of a plurality of seats satisfying the desired seat condition throughout the use route; when a plurality of combinations exist as a plurality of combination candidates of the combination, executing a score calculation process of calculating, for each of the plurality of combination candidates, a movement burden score indicating a magnitude of burden of movement of the user between the plurality of seats, based on the seat arrangement information and the seat reservation information; and presenting, to the user via a user device of the user, a combination candidate having a smallest movement burden score among the plurality of combination candidates.

According to the present disclosure, if a plurality of combinations of a plurality of seats satisfying the desired seat condition exist throughout the use route, a combination candidate having the smallest movement burden score is presented to the user even when the same seat satisfying the desired seat condition does not exist throughout the use route. Thus, it is possible to provide the user with a seat that satisfies the desire of the user throughout the use route and reduces the burden of movement between seats. This leads to further improvement in convenience of the user.

### BRIEF DESCRIPTION OF THE DRAWINGS

FIG. 1 is a diagram schematically showing an example of a configuration of a seat reservation system according to an embodiment;

FIG. 2 is a flowchart showing a first example of processing related to seat reservation;

FIG. 3 shows an example of a passenger vehicle which is appropriately referred to for the description of a calculation method of a movement burden score;

FIG. 4 shows another example of a passenger vehicle which is appropriately referred to for description of a calculation method of the movement burden score; and

FIG. 5 is a flowchart showing a second example of processing related to the seat reservation.

### DETAILED DESCRIPTION

Embodiments of the present disclosure will be described with reference to the accompanying drawings.

### 1. Configuration of Seat Reservation System

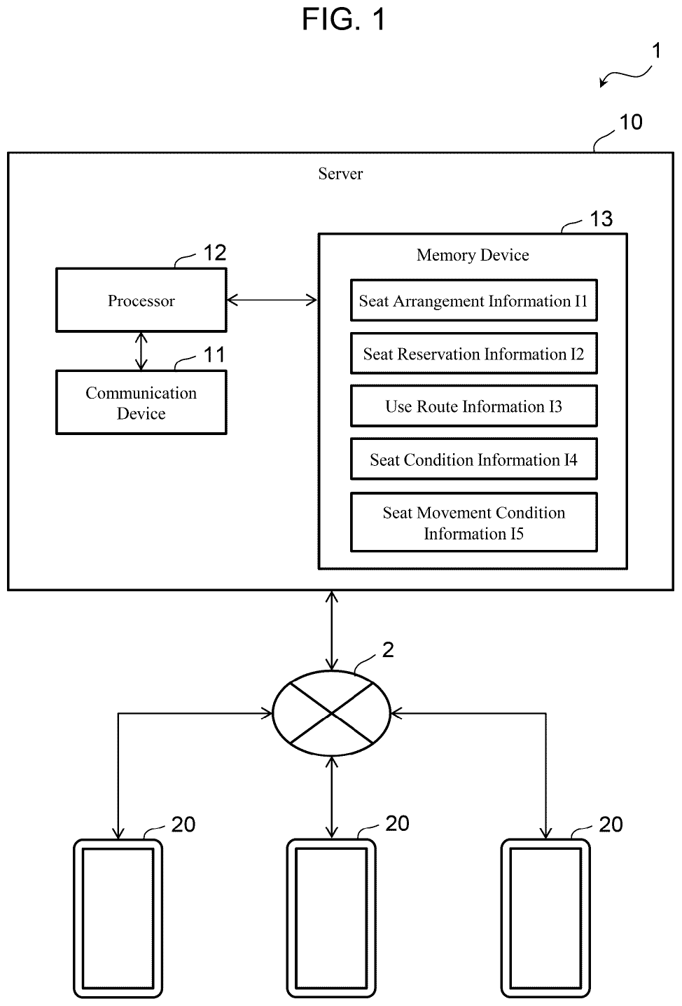

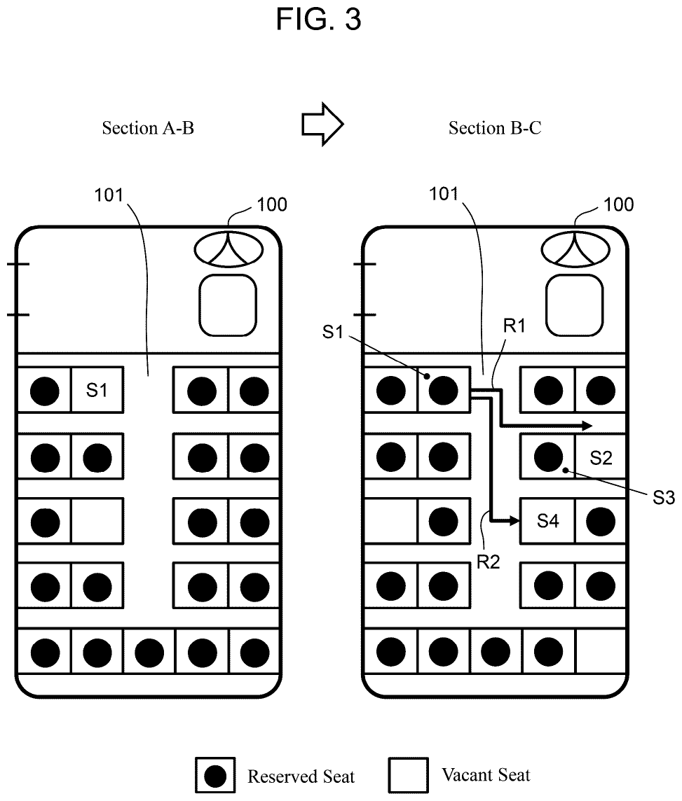

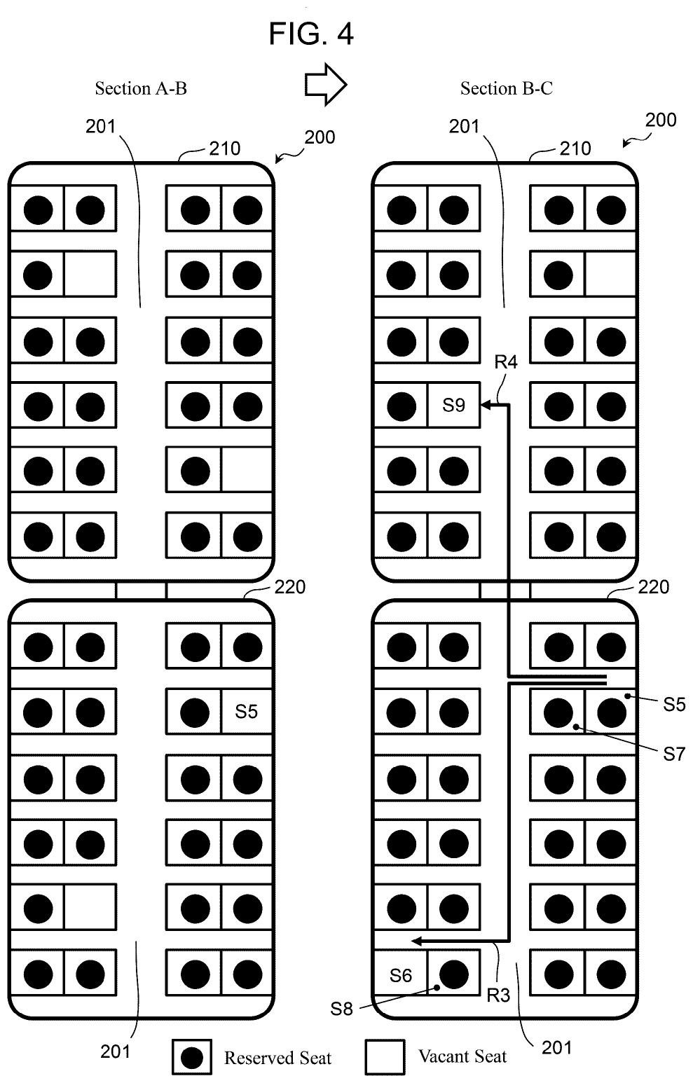

FIG. 1 is a diagram schematically showing an example of a configuration of a seat reservation system 1 according to an embodiment. The seat reservation system 1 manages seat reservations of a passenger vehicle. The passenger vehicle has a plurality of seats to be reserved by a plurality of users U. The passenger vehicle may be a single car (e.g., a passenger vehicle 100 shown in FIG. 3) or may be configured by coupling two or more cars (e.g., a passenger vehicle 200 shown in FIG. 4). Examples of the latter include an articulated bus and a train.

The seat reservation system 1 includes, for example, a server 10 and a user device 20 operated by each user U.

The server 10 includes a communication device 11, one or more processors 12 (hereinafter, simply referred to as a processor 12), and one or more memory devices 13 (hereinafter, simply referred to as a memory device 13).

The communication device 11 is configured to communicate with the user device 20 of each user U via a communication network 2.

The processor 12 executes various processes related to the seat reservation of the user U, which will be described below. Examples of the processor 12 include a central processing unit (CPU), a graphics processing unit (GPU), an application specific integrated circuit (ASIC), and a field-programmable gate array (FPGA). The processor 12 may also be referred to as circuitry or processing circuitry.

The memory device 13 stores various kinds of information. Examples of the memory device 13 include a volatile memory, a nonvolatile memory, a hard disk drive (HDD), and a solid state drive (SSD). The functions of the server 10 may be implemented by cooperation between the processor 12 that executes a management program and the memory device 13. The management program is stored in the memory device 13. Alternatively, the management program may be recorded in a computer-readable recording medium. The management program may be provided via a network.

The various kinds of information includes seat arrangement information I1, seat reservation information I2, use route information I3, and seat condition information I4. The various kinds of information may also include seat movement condition information I5 described below.

The seat arrangement information I1 indicates the arrangement of seats provided in the passenger vehicle that is a target of the seat reservation by each user U. The memory device 13 stores the seat arrangement information I1 of each passenger vehicle whose seat reservation is managed by the server 10.

The seat reservation information I2 indicates a seat reservation status of each user U for individual sections traveled by the passenger vehicle, and includes information on vacant seats in the individual sections and information on reserved seats in the individual sections. The individual sections mentioned here include sections between two adjacent stops or stations. The seat reservation information I2 is stored for each passenger vehicle. The seat reservation information I2 is appropriately updated depending on the status of seat reservations (including reservation cancellations) by each user U.

The use route information I3 indicates a use route that is used by each user U of the passenger vehicle and includes a plurality of sections traveled by the passenger vehicle. The user U who wants to reserve a seat of a passenger vehicle operates the user device 20 to transmit seat request information I0 to the server 10. The seat request information I0 includes, for example, a desired passenger vehicle, a desired use route, and a desired seat condition of the user U. For example, when receiving the seat request information I0 from the user device 20 operated by the user U, the server 10 stores the desired use route, which is included in the seat request information I0, in the memory device 13 as the use route information I3. The use route information I3 is also stored for each passenger vehicle.

The seat condition information I4 is information indicating a desired seat condition of the user U. Specifically, the desired seat condition may include a condition of seating location desired by the user U (for example, window side, aisle side, near/far from an entrance/exit, near/far from an in-vehicle facility (e.g., a toilet)). Moreover, the desired seat condition may include, for example, a condition of a seating grade (for example, an upgraded reserved seat, a normal reserved seat). Furthermore, the desired seat condition may include the presence or absence of a baggage storage space around the seat. For example, when receiving the seat request information I0 from the user device 20 operated by the user U, the server 10 stores the desired seat condition included in the seat request information I0 in the memory device 13 as the seat condition information I4.

The user device 20 is a communication terminal operated by the user U. The user device 20 is, for example, a mobile device such as a smartphone carried by the user U. More specifically, the user device 20 includes an input unit that receives an operation of the user U and an output unit that displays information to the user U.

### 2. Seat Reservation for Passenger Vehicle

When the user U who requests a seat reservation for a passenger vehicle for a use route including a plurality of sections cannot obtain the same seat throughout the use route, it is conceivable to present a combination of a plurality of seats involving movement of the user U between the seats. It is desirable to perform the presentation of the combination of the plurality of seats involving the movement of the user U between the seats as described above while more sufficiently improving the convenience of the user U who is riding in the passenger vehicle.

To be specific, when the user U moves between seats, the user U may need to request another user who is seated on the user U's own flow line to temporarily change his/her posture or temporarily leave his/her seat. This imposes a psychological burden on the user U who moves between the seats. Further, even if the movement distance between the seats is short, a movement between cars of the passenger vehicle may be a psychological burden on the user U as compared to a movement within the same car having a long movement distance.

Therefore, in the present embodiment, when the user U requests a seat reservation for a use route including a plurality of sections, the processor 12 of the server 10 executes the following “first search process”, “second search process”, “score calculation process”, and “presentation process”.

Specifically, the processor 12 executes the first search process in response to a request for the seat reservation from the user U. In the first search process, the processor 12 searches for the same seat satisfying the desired seat condition throughout the use route of the user U on the basis of the seat arrangement information I1, the seat reservation information I2, the use route information I3, and the seat condition information I4 that are described above.

The second search process is executed when the same seat does not exist. In the second search process, the processor 12 searches for a combination of a plurality of seats satisfying the desired seat condition throughout the use route.

The score calculation process is executed when a plurality of combinations of a plurality of seats exist as a “plurality of combination candidates”. In the score calculation process, the processor 12 calculates, for each of the plurality of combination candidates, a “movement burden score SCR” indicating the magnitude of the burden of the movement of the user U between a plurality of seats, based on the seat arrangement information I1 and the seat reservation information I2.

Then, in the presentation process, the processor 12 presents, to the user U via the user device 20, a combination candidate having the smallest movement burden score SCR among the plurality of combination candidates.

### 2-1. First Example

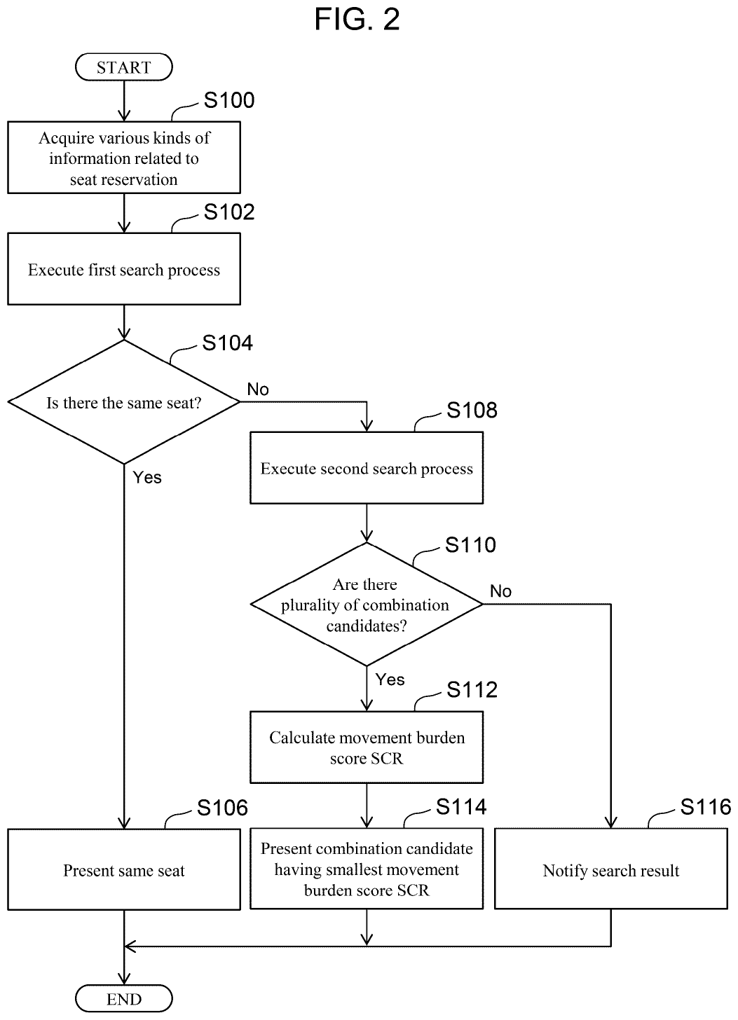

FIG. 2 is a flowchart showing a first example of processing related to the seat reservation. The processing of this flowchart is started in response to a request for a seat reservation from the user U for a use route including a plurality of sections.

In step S100, the processor 12 acquires various kinds of information related to the seat reservation, that is, the seat arrangement information I1, the seat reservation information I2, the use route information I3, and the seat condition information I4 from the memory device 13. Thereafter, the processing proceeds to step S102.

In step S102, the processor 12 searches for the same seat satisfying the desired seat condition throughout the use route of the user U on the basis of the seat arrangement information I1, the seat reservation information I2, the use route information I3, and the seat condition information I4 acquired in step S100. The process of step S102 corresponds to the first search process. Thereafter, the processing proceeds to step S104.

In step S104, the processor 12 determines whether or not the same seat described above has been found. As a result, when the same seat is found (step S104; Yes), the processing proceeds to step S106.

In step S106, the processor 12 presents the found same seat to the user U as a seat available for the reservation by the user U. More specifically, the processor 12 transmits to the user device 20 of the user U, seat information indicating the same seat. The user device 20 that has received the seat information displays the seat information on the output unit, such as a display.

When, on the other hand, the same seat is not found (step S104; No), the processing proceeds to step S108. In step S108, the processor 12 searches for a combination of a plurality of seats that satisfies the desired seat condition throughout the use route of the user U. The process of step S108 corresponds to the second search process. Thereafter, the processing proceeds to step S110.

In step S110, the processor 12 determines whether or not a plurality of combinations of the plurality of seats have been found as a plurality of combination candidates. As a result, when the plurality of combination candidates are found (step S110; Yes), the processing proceeds to step S112.

In step S112, the processor 12 calculates a movement burden score SCR of each of the plurality of combination candidates based on the seat arrangement information I1 and the seat reservation information I2. The process of step S112 corresponds to the score calculation process. Specifically, the processor 12 calculates a movement burden score SCR of each of the plurality of combination candidates by adding up individual scores SCR_i (i=1 to N) of a plurality of factors related to the burden of the movement of the user U between the plurality of seats.

Each of FIGS. 3 and 4 shows an example of a passenger vehicle which is appropriately referred to for the description of the calculation method of the movement burden score SCR. Here, as an example of the use route of the user U, a use route A-B-C including a section A-B from a point A to a point B and a section B-C from the point B to a point C is used. FIGS. 3 and 4 each illustrate an example of a reservation status of each of the section A-B and the section B-C when the user U makes a seat reservation. A passenger vehicle 100 shown in FIG. 3 is a bus. A passenger vehicle 200 shown in FIG. 4 is a train configured by coupling two cars 210 and 220. In each of FIGS. 3 and 4, seats marked with black circles indicate seats reserved by other users U, and seats not marked with black circles indicate vacant seats (i.e., unreserved seats). In both examples of FIGS. 3 and 4, there are no vacant seats throughout the use route A-B-C.

A first factor which is one of the “plurality of factors” described above is a number N1 of one or more reserved seats located between a seat before the movement of the user U (i.e., a seat of the movement source) and an aisle of the passenger vehicle and between the aisle and a seat after the movement of the user (i.e., a seat of the movement destination) when the user U moves between the plurality of seats. To be specific, in FIG. 3, moving routes R1 and R2 are illustrated as examples of the route of the movement of the user U between the seats at the point B. The moving route R1 relates to the movement from a seat S1 which is vacant in the section A-B to a vacant seat S2. In the moving route R1, one seat S3 corresponds to the one or more reserved seats located (i.e., existing) between an aisle 101 and a seat of the movement destination (i.e., vacant seat S2). That is, in this example, the number N1 of the one or more reserved seats, which is the first factor, is 1. The moving route R2 will be described below. In addition, in an example in which the use route includes three or more sections and two or more movements between seats are needed, the total value of the numbers of one or more reserved seats present in the respective movements between seats corresponds to the number N1 of one or more reserved seats.

Moreover, in FIG. 4, moving routes R3 and R4 are illustrated as examples of the route of the movement of the user U between the seats at the point B. The moving route R3 relates to the movement from a seat S5 which is vacant in the section A-B to a vacant seat S6. In the moving route R3, two seats S7 and S8 correspond to one or more reserved seats located (i.e., existing) between the seat S5 of the movement source and an aisle 201 and between the aisle 201 and a seat of the movement destination (i.e., vacant seat S6). That is, in this example, the number N1 of one or more reserved seats, which is the first factor, is 2. The moving route R4 will be described below.

A second factor which is another one of the “plurality of factors” described above is a number N2 of movements between cars (i.e., a car-to-car movement) of the passenger vehicle which occur when the user U moves between the plurality of seats. The moving route R4 illustrated in FIG. 4 relates to the movement from the seat S5 which is vacant in the section A-B to a vacant seat S9. This movement involves a car-to-car movement from the car 220 to the car 210. Therefore, in the example of the moving route R4, the number N2 of car-to-car movements, which is the second factor, is 1. In addition, for example, when another car (not illustrated) is interposed between the cars 220 and 210, the movement from the seat S5 to the vacant seat S9 is accompanied by the car-to-car movement from the car 220 to the another car and the car-to-car movement from the another car to the car 210. Therefore, in this example, the number N2 of car-to-car movements is 2. Further, in another example in which the use route includes three or more sections and two or more car-to-car movements are needed, the number N2 of car-to-car movements is the total value of the numbers of car-to-car movements performed in the respective movements between seats.

The individual score SCR_1 of the first factor and the individual score SCR_2 of the second factor can be calculated in accordance with, for example, the following Equations 1 and 2, respectively. Each of K1 and K2 is a positive coefficient.

$$SCR\_ 1 = K 1 \times N 1 \qquad ( 1 )$$

$$SCR\_ 2 = K 2 \times N 2 \qquad ( 2 )$$

According to Equation 1, the individual score SCR_1 is acquired by multiplying the number N1 of one or more reserved seats (first factor) by the first coefficient K1. As a result, the individual score SCR_1 is calculated to be higher when the number N1 of one or more reserved seats is larger. Similarly, according to Equation 2, the individual score SCR_2 is acquired by multiplying the number N2 f car-to-car movements (second factor) by the second coefficient K2. As a result, the individual score SCR_2 is calculated to be higher when the number N2 of car-to-car movements is larger.

The first coefficient K1 and the second coefficient K2 may be the same value. Alternatively, the first coefficient K1 and the second coefficient K2 may be values different from each other. That is, the first coefficient K1 and the second coefficient K2 may be used as the following weighting coefficients. In the first example, in order to make the weight of the individual score SCR_2 with respect to the movement burden score SCR larger than the weight of the individual score SCR_1 with respect to the movement burden score SCR, the second coefficient K2 is set to be larger than the first coefficient K1. Additionally, in contrast to this setting, the first coefficient K1 may be set to be larger than the second coefficient K2.

In step S114 subsequent to step S112, the processor 12 specifies a combination candidate having the smallest movement burden score SCR among the plurality of combination candidates. Then, the processor 12 presents the specified combination candidate to the user U via the user device 20. The process of step S112 corresponds to the presentation process. More specifically, the processor 12 transmits seat information indicating the combination candidate to the user device 20 of the user U. The user device 20 that has received the seat information displays the seat information on the output unit, such as a display. It should be noted that, in an example in which there are a plurality of combination candidates having the smallest and same movement burden score SCR, the processor 12 may select any one of the plurality of combination candidates and transmit the selected combination candidate to the user device 20, or may transmit all of the plurality of combination candidates and leave the selection of the combination of the plurality of seats to the user U.

In relation to the identification of the combination candidate having the smallest movement burden score SCR, specific examples EX1 and EX2 are described as follows. Here, in one example, the first coefficient K1 is 1, and the second coefficient K2 is 5.

In the description of the specific example EX1, the combination of the seats S1 and S2 and the combination of the seats S1 and S4 in the passenger vehicle 100 (see FIG. 3) are focused on as two combination candidates. First, in the example of the movement from the seat S1 to the vacant seat S2 at the point B (i.e., the moving route R1), the number N1 of one or more reserved seats is 1 (seat S3) as described above, and the number N2 of car-to-car movements is 0. As a result, the individual score SCR_1 becomes 1 (=1×1), and the individual score SCR_2 becomes 0, and thus the movement burden score SCR becomes 1 (=1+0). On the other hand, in the example of the movement from the seat S1 to the vacant seat S4 at the point B (i.e., the moving route R2), the number N1 of one or more reserved seats N1 is 0, and the number N2 of car-to-car movements is also 0. As a result, both the individual scores SCR_1 and SCR_2 become 0, and thus the movement burden score SCR also becomes 0. Therefore, in the specific example EX1, the latter combination candidate (seats S1 and S4) is specified as the combination candidate having the smallest movement burden score SCR.

In the description of the specific example EX2, the combination of the seats S5 and S6 and the combination of the seats S5 and S9 in the passenger vehicle 200 (see FIG. 4) are focused on as two combination candidates. First, in the example of the movement from the seat S5 to the seat S6 at the point B (i.e., the moving route R3), the number N1 of one or more reserved seats is 2 (seats S7 and S8) as described above, and the number N2 of car-to-car movements is 0. As a result, the individual score SCR_1 becomes 2 (=1×2), and the individual score SCR_2 becomes 0, and thus the movement burden score SCR becomes 2. On the other hand, in the example of the movement from the seat S5 to the seat S9 at the point B (i.e., the moving route R4), the number N1 of one or more reserved seats is 1 (seat S7), and the number N2 of car-to-car movements is 1 as described above. As a result, the individual score SCR_1 becomes 1 (=1×1), and the individual score SCR_2 becomes 5 (=5×1), and thus the movement burden score SCR becomes 6 (=1+5). Therefore, in this example, the former combination candidate (seats S5 and S6) is specified as the combination candidate having the smallest movement burden score SCR.

Additionally, in order to specify the combination candidate having the smallest movement burden score SCR, a movement distance D between the seats in the movement of the user U between the plurality of seats may be included as a further factor among the plurality of factors. For example, the individual score SCR_i may be calculated to be higher when the movement distance D is longer.

On the other hand, when the plurality of combination candidates are not found (step S110; No), the processing proceeds to step S116. In step S116, the processor 12 notifies the user U of a seat search result via the user device 20. Specifically, when only one combination candidate is found, the processor 12 presents the combination candidate to the user U. Further, when no combination candidate is found, the processor 12 may perform, for example, notification indicating that a seat satisfying the desired seat condition is not found even after considering the movement between seats. Alternatively, for example, the processor 12 may notify the user U of information indicating all vacant seats in the use route of the user U regardless of whether or not the desired seat condition of the user U is satisfied.

### 2-2. Second Example

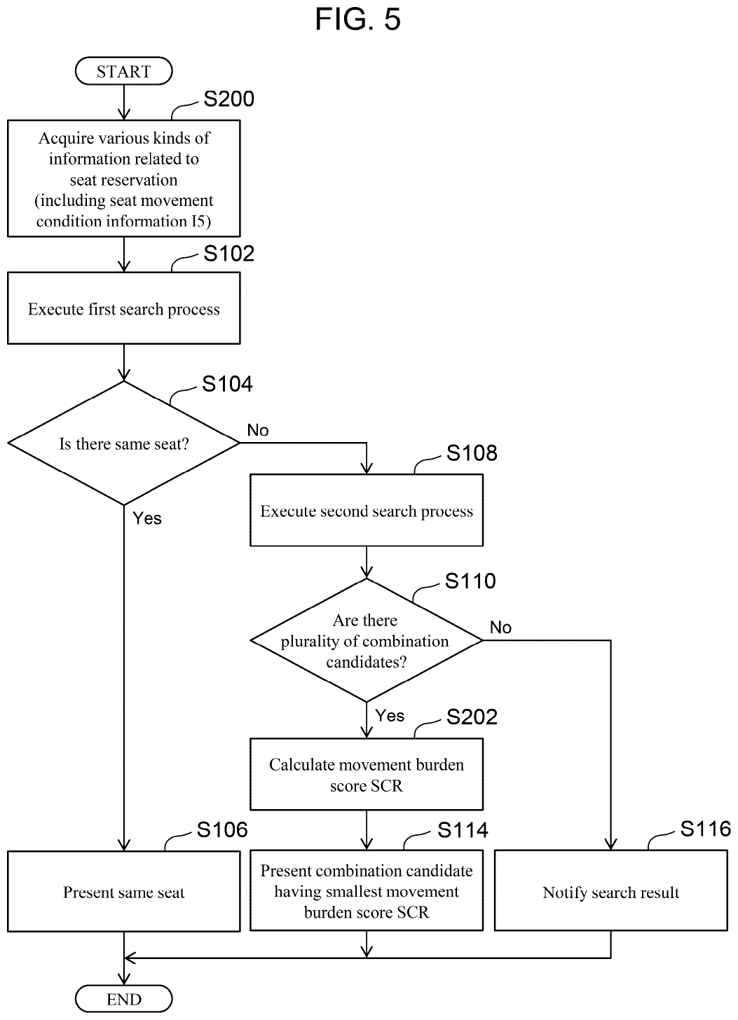

FIG. 5 is a flowchart showing a second example of processing related to the seat reservation. The processing of this flowchart is different from the processing of the flowchart shown in FIG. 2 in the following points.

To be specific, the seat request information I0 that the server 10 receives from the user device 20 when the user U makes a seat reservation for the passenger vehicle may include seat movement condition information I5 together with the use route information I3 and the seat condition information I4. The server 10 stores, in the memory device 13, the seat movement condition information I5 received from the user device 20.

The seat movement condition information I5 indicates a seat movement condition that is permitted (i.e., allowed) by the user U when the same seat is not found throughout the use route. When making a seat reservation, the user U inputs the seat movement condition information I5 to the user device 20. The seat movement condition includes, for example, “permission or non-permission of the car-to-car movement”, “desire to move to a seat as close as possible”, “desire to move to a seat as close as possible to an aisle”, and “desire to move to a seat as close as possible to a window”.

In FIG. 5, in step S200, the processor 12 acquires the seat movement condition information I5 described above, together with the seat arrangement information I1, the seat reservation information I2, the use route information I3, and the seat condition information I4.

Moreover, in step S202 (score calculation process) of FIG. 5, in accordance with the seat movement condition of the user U, the processor 12 changes the first coefficient K1 and the second coefficient K2 used for calculating the individual scores SCR_1 and SCR_2. That is, in the second example, the first coefficient K1 and the second coefficient K2 are used as weighting coefficients according to the seat movement condition.

To be specific, when the user U permits the car-to-car movement, the processor 12 may change the second coefficient K2 such that the second coefficient K2 becomes smaller than that when the user U does not permit the car-to-car movement. Moreover, when the seat movement condition includes “desire to move to a seat as close as possible”, the processor 12 may change the first coefficient K1 and the second coefficient K2 such that each of the first coefficient K1 and the second coefficient K2 becomes smaller when the movement distance D is shorter than a designated threshold value than when the movement distance D is longer than or equal to the threshold value. Furthermore, when the seat movement condition includes “desire to move to a seat as close as possible to an aisle”, the processor 12 may change the first coefficient K1 and the second coefficient K2 such that each of the first coefficient K1 and the second coefficient K2 becomes smaller when the seat of the movement destination included in the combination candidate is a seat on the aisle side than when the seat of the movement destination is a seat on the window side. Similarly, when the seat movement condition includes “desire to move to a seat as close as possible to a window”, the processor 12 may change the first coefficient K1 and the second coefficient K2 such that each of the first coefficient K1 and the second coefficient K2 becomes smaller when the seat of the movement destination included in the combination candidate is a seat on the window side than when the seat of the movement destination is a seat on the aisle side.

### 3. Effect

As described above, according to the seat reservation system 1 of the present embodiment, if a plurality of combinations of a plurality of seats satisfying the desired seat condition exist throughout the use route, a combination candidate having the smallest movement burden score SCR is presented to the user U even when the same seat satisfying the desired seat condition does not exist throughout the use route. Thus, it is possible to provide the user U with a seat that satisfies the desire of the user U throughout the use route and reduces the burden of movement between seats. This leads to further improvement in convenience of the user U. In addition, it can be said that the satisfaction of the desired seat condition of the user U itself leads to the reduction of the burden of movement of the user U.

Moreover, in the present embodiment, the plurality of factors related to the burden of the movement of the user U between the plurality of seats include the number N1 of one or more reserved seats (i.e., the first factor) and the number N2 of car-to-car movements (i.e., the second factor). The individual score SCR_1 of the first factor is calculated to be higher when the number N1 of one or more reserved seats is larger, and the individual score SCR_2 of the second factor is calculated to be higher when the number N2 of car-to-car movements is larger. Thus, it is possible to appropriately reduce the presentation of a combination candidate, which may impose a psychological burden as described above, to the user U who moves between seats.

Moreover, as in the first example described above, the first coefficient K1 and the second coefficient K2 by which the individual score SCR_1 of the first factor and the individual score SCR_2 of the second factor are respectively multiplied may be values different from each other. This makes it possible to provide a difference between the individual scores SCR_1 and SCR_2 in consideration of the difference between the first and second factors. This leads to calculation of a more appropriate movement burden score SCR in consideration of the first and second factors.

Furthermore, as in the second example described above, at least one of the first coefficient K1 and the second coefficient K2 may be changed in accordance with the seat movement condition permitted by the user U. The degree of psychological burden on the user U for, for example, the car-to-car movement may differ depending on whether or not the seat movement condition permitted by the individual user U is satisfied. Therefore, changing at least one of the first coefficient K1 and the second coefficient K2 in accordance with the seat movement condition leads to improvement in convenience of the user U.

What is claimed is:

1. A seat reservation system for managing seat reservations for a passenger vehicle, comprising:
one or more memory devices configured to store seat arrangement information of the passenger vehicle, seat reservation information indicating a seat reservation status for individual sections traveled by the passenger vehicle, use route information indicating a use route that is used by a user and includes a plurality of sections traveled by the passenger vehicle, and seat condition information indicating a desired seat condition of the user; and
processing circuitry configured to:
search for a same seat satisfying the desired seat condition throughout the use route, based on the seat arrangement information, the seat reservation information, the use route information, and the seat condition information;
when the same seat does not exist, search for a combination of a plurality of seats satisfying the desired seat condition throughout the use route;
when a plurality of combinations exist as a plurality of combination candidates of the combination, execute a score calculation process of calculating, for each of the plurality of combination candidates, a movement burden score indicating a magnitude of burden of movement of the user between the plurality of seats, based on the seat arrangement information and the seat reservation information; and
present, to the user via a user device of the user, a combination candidate having a smallest movement burden score among the plurality of combination candidates.

2. The seat reservation system according to claim 1, wherein
in the score calculation process, the processing circuitry calculates the movement burden score for each of the plurality of combination candidates by adding up individual scores for each of a plurality of factors related to the burden,
the plurality of factors include:
a first factor being a number of one or more reserved seats located between a seat before movement of the user and an aisle of the passenger vehicle and between the aisle and a seat after the movement of the user when the user moves between the plurality of seats; and
a second factor being a number of movements between cars of the passenger vehicle that occur when the user moves between the plurality of seats,
the individual score of the first factor is higher when the number of the one or more reserved seats is larger, and
the individual score of the second factor is higher when the number of movements between the cars is larger.

3. The seat reservation system according to claim 2, wherein
the individual score of the first factor is the number of the one or more reserved seats multiplied by a first coefficient,
the individual score of the second factor is the number of movements between the cars multiplied by a second coefficient, and
the first coefficient and the second coefficient are different from each other.

4. The seat reservation system according to claim 2, wherein
the one or more memory devices are further configured to store seat movement condition information indicating a seat movement condition permitted by the user,
the individual score of the first factor is the number of the one or more reserved seats multiplied by a first coefficient,
the individual score of the second factor is the number of movements between the cars multiplied by a second coefficient, and
in the score calculation process, the processing circuitry changes at least of the first coefficient and the second coefficient in accordance with the seat movement condition.

5. A seat reservation method for managing seat reservations for a passenger vehicle, the seat reservation method, which is executed by a computer, comprising:
searching for a same seat satisfying a desired seat condition of a user throughout a use route, based on seat arrangement information of the passenger vehicle, seat reservation information indicating a seat reservation status for individual sections traveled by the passenger vehicle, use route information indicating the use route that is used by the user and includes a plurality of sections traveled by the passenger vehicle, and seat condition information indicating the desired seat condition;
when the same seat does not exist, searching for a combination of a plurality of seats satisfying the desired seat condition throughout the use route;
when a plurality of combinations exist as a plurality of combination candidates of the combination, executing a score calculation process of calculating, for each of the plurality of combination candidates, a movement burden score indicating a magnitude of burden of movement of the user between the plurality of seats, based on the seat arrangement information and the seat reservation information; and
presenting, to the user via a user device of the user, a combination candidate having a smallest movement burden score among the plurality of combination candidates.
